(19) United States
(12) Patent Application Publication
(10) Pub. No.: US 2014/0150067 A1
(43) Pub. Date: May 29, 2014

(54) SYSTEM AND METHOD FOR NETWORK CONTROLLED P2P DEVICE DISCOVERY

(71) Applicant: MOTOROLA MOBILITY LLC, Libertyville, IL (US)

(72) Inventors: Apostolis K. Salkintzis, Athens (GR); David E. Halasz, Stow, OH (US); Dwight R. Smith, Grapevine, TX (US)

(73) Assignee: MOTOROLA MOBILITY LLC, Libertyville, IL (US)

(21) Appl. No.: 13/686,506

(22) Filed: Nov. 27, 2012

(51) Int. Cl. G06F 21/31

(52) U.S. Cl. CPC G06F 21/31
USPC 726/4

(57) ABSTRACT

Embodiments of the present invention provide a system and method that provides a user within a P2P network the ability to discover other devices in their vicinity, but under control of the network operator.

### BACKGROUND

Embodiments of the invention relate to a system for determining nearby individuals within a social network.

In many local Peer-to-Peer (P2P) networks, devices within a specified geographic area are able to discover all other devices within the area or devices with a certain type only (e.g. headphones, mobile devices, storage, etc.). Local P2P networks may be created via Bluetooth, wired or wireless Internet, or cellular networks. In some cases, a network operator may want to allow a user to discover nearby devices operated by other users and may charge the user for using such discovery services. The network operator may also want to prohibit a user from discovering nearby devices operated by other users, e.g. when the user has not paid for discovery services. Additionally, the network operator may want to control which nearby devices a user can discover and establish P2P communications with, based e.g. on the user's subscription settings. As an example, the network operator may want to allow a business user to discover only nearby devices operated by users working in the same company.

### BRIEF SUMMARY OF THE DRAWINGS

FIG. 1 illustrates a communication system in accordance with embodiments;

FIG. 2 illustrates the user equipment of FIG. 1 in accordance with embodiments;

FIG. 3 illustrates a method by which the system of FIG. 1 is formed in accordance with embodiments;

FIG. 4 illustrates example data structures associated with user IDs in accordance with embodiments;

FIG. 5 illustrates a spatial relationship between users in accordance with embodiments; and

FIG. 6 illustrates a method by which user equipment devices are discovered and connected in accordance with embodiments.

### DETAILED DESCRIPTION

Embodiments of the present invention provide a system and method that provides users within a P2P network the ability to discover other devices in their vicinity, but under control of the network operator.

Embodiments of the present invention are drawn to a device including a transmitting portion, a receiving portion, a determining portion and an indicating portion. The transmitting portion may transmit registration data to an application server and may transmit an authorization to the application server to access user data at a second server. The receiving portion may receive, from the application server, a plurality of received user identities (user-IDs) based on the user data, wherein each of the plurality of user-IDs corresponds to one of a plurality of user names, respectively. The receiving portion may additionally receive, from a transmitting user equipment, a probe request including a transmitting user-ID. The determining portion may determine whether the transmitting user-ID corresponds to one of the plurality of received user-IDs. The indicating portion may provide a presence indication of the transmitting user equipment when the transmitting user-ID corresponds to one of the plurality of received user-IDs. The indicating portion may additionally provide no presence indication of the transmitting user equipment when the transmitting user-ID does not correspond to one of the plurality of received user-IDs.

Embodiments include devices and methods for devices to discover each other via a local P2P network. Users will register with both their mobile carrier and a social network site, and then provide their mobile carrier with their login information for the social network site. The social network site may be deployed and operated by the mobile carrier or by a third party. The mobile carrier may then create unique user IDs for each contact in a user's contact list, and provide those unique user IDs to any equipment owned by the user (mobile phone, tablet computer, etc.). When devices are logged on to the mobile network in a similar geographic location and P2P discovery messages (e.g. probe requests and responses) are sent and received, a user will only be notified of the presence of devices owned by contacts on the user's social network, based on the unique user IDs assigned to each contact by the mobile carrier.

A device discovery request occurs when a device transmits a probe request to announce its presence and to trigger nearby devices to respond. The transmitting device and receiving device(s) must all be connected to the same server, software or application in order for any P2P discovery and connections to be made, as the request(s) will be routed through the server, software or application. The discovery request can be sent via the Internet (wired or wireless), a cellular network, a Bluetooth network, or any other type of network known to those of ordinary skill in the art. The request includes information including the identity of the user that is operating the device initiating the discovery request. Embodiments of the present invention include any known system for device discovery. Once a device is discovered, aspects of the present invention enable direct P2P communication by known methods, non-limiting examples of which include Wi-Fi and Bluetooth.

According to various embodiments, device discovery includes any method of determining the presence of a device. Example methods for determining the presence of a device include GPS (global positioning system) utilizing satellites and LPS (local positioning system) utilizing WiFi, cellular base stations or radio broadcast towers. Example methods for WiFi-based device discovery are specified in the WiFi Peer-to-Peer technical specification, developed by the WiFi Alliance. Embodiments of the present invention may include any system for device discovery.

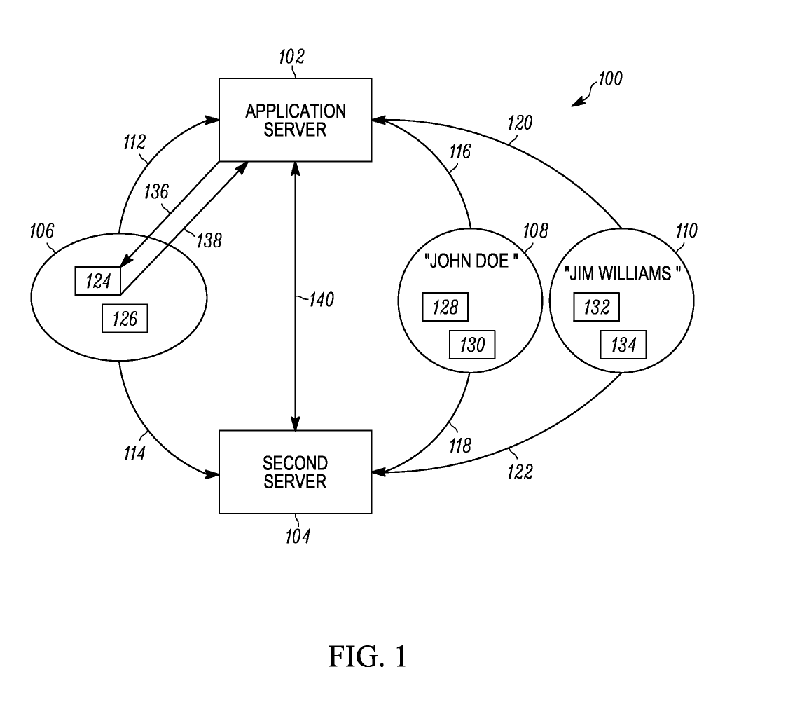

Detailed descriptions of embodiments will now be described with reference to FIGS. 1-6.

FIG. 1 illustrates a communication system in accordance with embodiments.

As shown in the figure, communication system 100 includes an application server 102, a second server 104 and users 106-110. User 106 includes user equipment 124 and 126, user 108 includes user equipment 128 and 130 and user 110 includes user equipment 132 and 134.

Application server 102 is a computer hardware system associated with a wireless service provider, examples of which include Verizon™, AT&T™, Sprint™, or any other network provider. Application server 102 is provides information or data to user devices 124-134.

Second server 104 is a computer hardware system associated with a social networking site, which is deployed and operated by the wireless service provider or by a third party, examples of which include Facebook™, MySpace™, or any other social networking site known to those of ordinary skill in the art. Second server 104 is dedicated to storing and providing information for individual users regarding connections with friends, status updates, and all other activities associated with social networking.

In some instances, for purpose of discussion, application server 102 may be referred to as the service provider whereas second server 104 may be referred to as the social network.

User equipment 124-134 includes any device that can access application server 102, which include cellular phones, laptop computers, desktop computers, tablet computers, or any other device equipped with either cellular network communication system or wired or wireless Internet connection system.

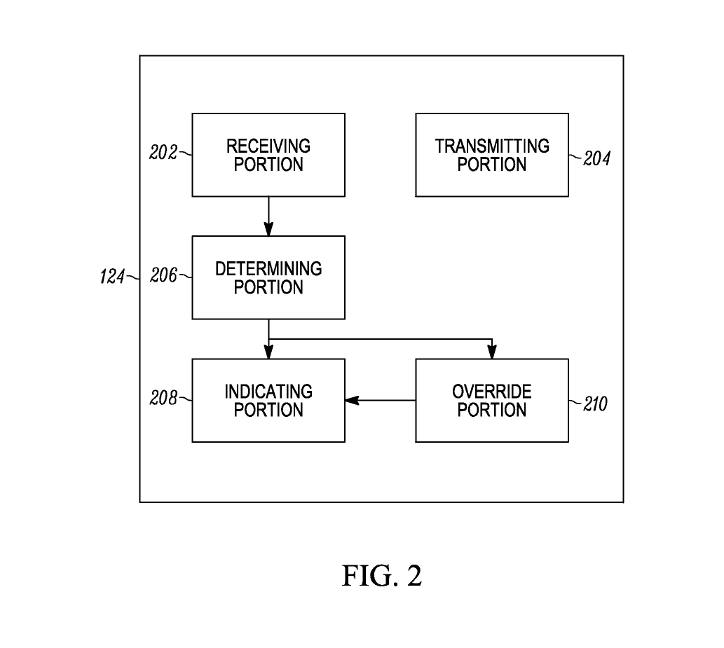

FIG. 2 illustrates the user equipment of FIG. 1 in accordance with various embodiments.

As shown in the figure, user equipment 124 includes a receiving portion 202, a transmitting portion 204, a determining portion 206, an indicating portion 208 and an override portion 210.

In this example, each of receiving portion 202, transmitting portion 204, determining portion 206, indicating portion 208 and override portion 210 are distinct devices. However, in other embodiments, at least two of receiving portion 202, transmitting portion 204, determining portion 206, indicating portion 208 and override portion 210 may be combined as a unitary device. Further, in some embodiments, at least one of receiving portion 202, transmitting portion 204, determining portion 206, indicating portion 208 and override portion 210 may be implemented as non-transient, tangible computer-readable media for carrying or having computer-executable instructions or data structures stored thereon. Such non-transient, tangible computer-readable media can be any available media that can be accessed by a general purpose or special purpose computer. Non-limiting examples of non-transient, tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (hardwired and/or wireless, or a combination of hardwired or wireless) to a computer, the computer properly views the connection as a non-transient, tangible computer-readable media computer-medium. Thus, any such connection is properly termed a non-transient, tangible computer-readable medium. Combinations of the above should also be included within the scope of non-transient, tangible computer-readable media.

Receiving portion 202 is arranged to receive device discovery requests (also referred to as probe requests) from other user equipment and communicate information contained within the device discovery request to determining portion 206. Device discovery requests announce the present of a user equipment and include information regarding the users associated with the user equipment sent the discovery request. Device discovery requests may be received by any known method, as described above (e.g., Internet, cellular network, WiFi, Bluetooth, etc). In an example embodiment, a device discovery request is a peer-to-peer Probe Request, as specified in the Wi-Fi Peer-to-Peer technical specification.

Transmitting portion 204 is arranged to transmit data and send device discovery requests from user equipment 124. Data transmitted by transmitting portion 204 include registration data to register with servers. Device discovery requests transmitted by transmitting portion 204 include information regarding the user associated with user equipment 124.

Determining portion 206 is arranged to receive communications from receiving portion 202 and communicate with indicating portion 208 and override portion 210. Determining portion 206 receives information from receiving portion 202 regarding device discovery requests from other user equipment and determines whether the device discovery request is originating from a user equipment associated with a known user. Based on the information received, determining portion 206 will then communicate with both indicating portion 208 and override portion 210.

Indicating portion 208 is arranged to receive communications from determining portion 206 and override portion 210. Depending on the communication(s) received, indicating portion 208 will indicate the presence of the user of user equipment that has sent a device discovery request (if the user is known) or it will not indicate presence of the user of user equipment that has sent a device discovery request (if the user is not known). In an example embodiment, user equipment 124 may include a graphic user interface (GUI), and indicating portion 208 may display a list on the GUI to indicate to the user the presence of friends or acquaintances in the area.

Override portion 210 is arranged to communicate with indicating portion 208 and provide an override signal to prevent indicating portion 208 from providing notifications to the user. In embodiments, override portion 210 will prevent indicating portion 208 from notifying a user of the presence of an unknown person, even if that person is in the immediate area of the user, thus saving the user time when determining whether or not any of the users in the immediate area are friends or acquaintances and enabling the wireless service provider to prohibit a user from discovering other users which should not be discoverable according to the user's subscription settings.

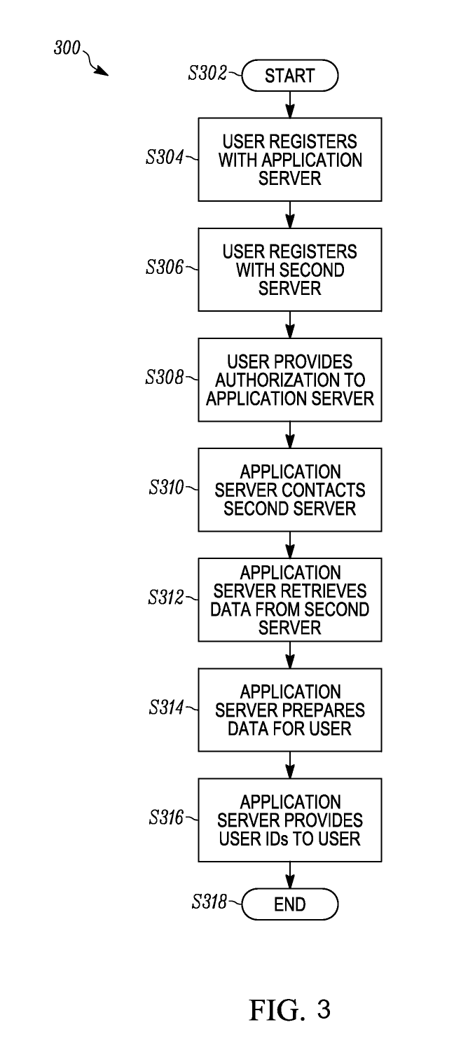

The operation of user equipment 124 will be further described with reference to FIG. 3.

FIG. 3 illustrates a method 300 by which the system of FIG. 1 is formed in accordance with embodiments.

As shown in the figure, method 300 starts (S302) and users register with an application server (S304). Referring to FIGS. 1-2, user 106 registers with application server 102 via user equipment 124 by sending registration data 112 from transmitting portion 204. User 106 could have registered with user equipment 126, or any other device user 106 owns, however, for purposes of brevity and explanation, presume user 106 registers via user equipment 124. User 108 registers with application server 102 by sending registration data 116 and user 110 registers with application server 102 by sending registration data 120. Registration data 112, 116 and 120 include user credentials such as username and password. The user credentials may be used to identify the user and to authorize access to application server 102.

In other words, in the above example, users 106-110 all register with the service provider and provide registration data so that the users can be authenticated and authorized access to application server 102.

Returning to FIG. 3, users register with a second server (S306). Referring to FIGS. 1-2, user 106 registers with second server 104 via user equipment 124 by sending registration data 114 from transmitting portion 204. User 108 registers with second server 104 by sending registration data 118 and user 110 registers with second server 104 by sending registration data 122. Registration data 114, 118 and 122 include user identifying data such as name, contact information, and the preferred user ID and password for account access.

For purposes of discussion, in the example above, users 106-110 all register with the social network and compile lists of friends and contacts that are stored within the social network. In this example, registration with the second server (S306) is illustrated as being performed after registration with the application server (S304). However, registration with the second server (S306) may occur before registration with the application server (S304). For example, assuming that Verizon™ provides services for application server 102, whereas Facebook™ provides services for second server 104. In an example embodiment, users 106, 108 and 110 may have been registered (e.g., S306) with Facebook™ for years before they register (e.g., S304) with Verizon™.

Referring back to FIG. 3, a user then provides authorization to an application server (S308). With reference to FIGS. 1-2, user 106 provides authorization to application server 102 via transmitting portion 204 for application server 102 to contact second server 104. The authorization includes user data 138 that includes the username and password for user 106 to log on to second server 104. Returning to the example using the service provider and the social network, user 106 provides the service provider with her login information (login ID and password) to access her account on the social network.

Returning to FIG. 3, the application server then contacts the second server (S310). In an example embodiment, for example as shown in FIG. 1, application server 102 contacts second server 104 as shown by arrow 140.

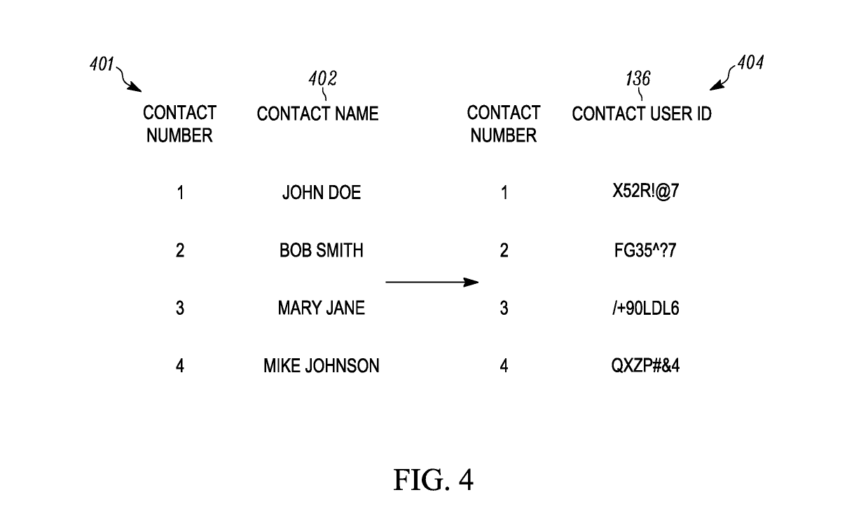

Referring back to FIG. 3, an application server retrieves data from the second server (S312). With reference to FIGS. 1-2, application server 102 contacts second server 104 and provides second server 104 with user data 136 to access the account information for user 106 on second server 104. Second server 104 then provides application server 102 with information regarding the contacts user 106 has stored on second server 104. With reference now to FIG. 4, the information provided to application server 102 includes the contact name 402 of each of the contacts of user 106. Again, returning to the example using the service provider and the social network, the service provider would use the information provided to it by user 106 and access the social network account of user 106. While logged in to the social network account, the service provider would access the list of contacts of user 106 that includes the contact name 402 of every contact known by user 106.

In some embodiments, not all contacts are provided to the application server. For example, in some embodiments, the second server may only provide contacts that are geographically co-located with the user. In one example, Verizon™ provides services for application server 102, whereas Facebook™ provides services for second server 104. In this example, let user 106 have many friends within his Facebook™ account, wherein many friends are located all over the world, but only user 108 is geographically co-located, e.g. relatively near, user 106. Application server 102 may only provide user 106 with user-IDs for Facebook™ friends that are geographically co-located, and not all the Facebook™ friends. As such, in this example, application server 102 may only provide user 106 with a user-ID for user 108.

Referring back to FIG. 3, the application server then prepares the data for the user (S314). An example of preparing data will now be described with reference to FIG. 4.

As shown in the figure, contact list 401 includes all of the contact names 402 for user 106 as they would be found on the social network account of user 106. Contact list 404 includes contact user IDs 136 that correspond with contact names 402.

While application server 102 is logged in to an account of the social network, it will assign contact user IDs 136 that are different from contact names 402 to each contact for user 106. For example, user 106 has a contact by the name of John Doe, and application server 102 creates a contact user ID of X52R!@7 that corresponds to John Doe. In addition, application server 102 also assigns a contact user ID to user 106.

Referring back to FIG. 3, the application server then provides the user IDs to the user (S316). With reference to FIGS. 1-2, application server 102 provides contact user IDs 136 to user equipment 124 and method 300 ends (S318).

Returning to the example using the service provider and the social network, after the service provider logs on to the social network account of user 106 and accesses the list of contact names 402, the service provider proceeds to create contact user IDs 136 that correspond to contact names 402. In addition, the service provider also creates a contact user ID for user 106 as well.

Contact user IDs 136 will not change. For example, discussions above have focused on user 106 providing access to her social network account and the service provider assigning contact user IDs 136. If user 108 were to provide the service provider access to his social network account, the contact user ID previously assigned to user 108 during the registration of user 106 will continue to be the contact ID for user 108. Referring to FIG. 4, the contact user ID of user 108 would always be X52R!@7.

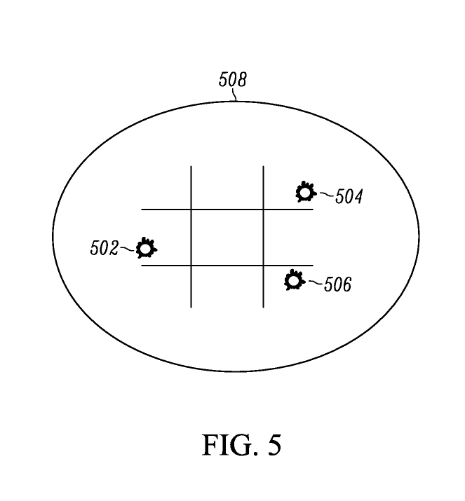

FIG. 5 illustrates a spatial relationship between users in accordance with embodiments.

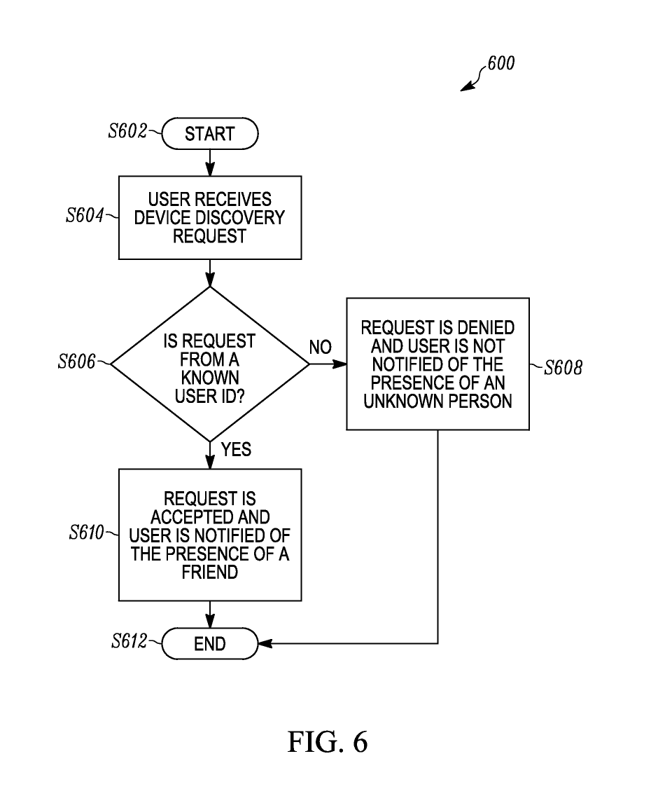

As shown in the figure, an icon 502, an icon 504 and an icon 506 are displayed within a geographic region 508. Icon 502 corresponds to the location of user 106, icon 504 corresponds to the location of user 108 and icon 506 corresponds to the location of user 110. Users 106, 108 and 110 are all located within the same geographic region 508. For example, users 106-110 may be in the same building, or in the same meeting room, or they may be attending the same sporting event, or in any other area that provides for direct radio communication between the users. Now that since users 106-110 are registered, it is possible for users to discover each other. For example, at the sporting event, users 106-110 may be carrying some form of user equipment that can connect to the service provider. As their respective user devices send and receive device discovery requests, the service provider is able to provide information regarding the identity of the users behind the discovery requests. This method will be further described with reference to FIG. 6.

FIG. 6 illustrates a method 600 by which user equipment devices are discovered and connected in accordance with embodiments.

As shown in the figure, method 600 starts (S602) and a user receives a device discovery request (S604), e.g. a probe request according to WiFi P2P specification. For example, and referring to FIGS. 1 and 4, users 106, 108 and 110 may be in the same geographic location 508, and all of users 106-110 may be logged on to application server 102. If users 106-110 have a mobile phone with the same provider as application server 102, logging on to application server 102 may be passive, meaning the user is logged on to application server 102 simply by turning on the mobile phone. If users 106-110 have a device other than a mobile phone, it may be necessary to actively log on to application server 102, meaning that the user must choose to log on to application server 102 by starting a program or a separate application on the device being used to access application server 102.

For purposes of discussion, consider the situation where users 108 (John Doe) and 110 (Jim Williams) are near user 106, and user 106 has chosen to be notified when her friends of the social network are in the same area as user 106.

Referring to FIGS. 1-2, in this example user equipment 128 is sufficiently close to user equipment 124 such that user equipment 128 can transmit a device discovery request directly to user equipment 124, e.g. via Wi-Fi. In such a case, user equipment 124 would receive a device discovery request from user equipment 128, which belongs to user 108 (John Doe) and from user equipment 132, which belongs to user 110 (Jim Williams). The device discovery requests are transmitted by transmitting portions of user equipment 128 and 132, and received by receiving portion 202 of user equipment 124. The device discovery request includes the contact user ID assigned to the user by application server 102.

Returning to FIG. 6, the user equipment receiving the request(s) must determine whether or not the request is from a known user ID (S606). Referring to FIGS. 1, 2 and 4, receiving portion 202 provides the device discovery request information to determining portion 206. Determining portion 206 then compares the contact user IDs contained within the device discovery requests to the list of known contact user IDs 136.

Returning to FIG. 6, if the contact user ID is not known (NO at S606), then the request is denied and the presence of the unknown user ID is not shown (S608). Referring to FIGS. 1, 2 and 4, determining portion 206 determines that the contact user ID associated with user 110 does not match the list of known contact user IDs 136, meaning that user 106 does not have user 110 (Jim Williams) as a contact on second server 104. Determining portion 206 relays that information to override portion 210, which then prevents indicating portion 208 from indicating a presence of user 110 to user 106. Method 600 then ends (S612).

User 106 will benefit from not being notified that user 110 is in the same area as user 106, because user 106 will not have to waste time attempting to determine whether she knows user 110. User 106 may also be restricted from discovering user 110 due to subscription limitations, e.g. because user 106 is not allowed by the service provider to discover user 110, or user 106 has not paid for being able to discover user 110.

Returning to FIG. 6, if the contact user ID is known (YES at S606), then the request is accepted and the presence of the known user ID is shown (S610). Referring to FIGS. 1, 2 and 4, determining portion 206 determines that the contact user ID associated with user 108 matches the list of known contact user IDs 136, meaning that user 106 has user 108 (John Doe) as a contact on second server 104. For example, user 106 is friends with John Doe on the social network, so John Doe is part of list of contact names 402 of user 106, and was thus also assigned a contact user ID 136 by the service provider. Determining portion 206 relays that information to indicating portion 208. Indicating portion 208 then provides notification to the user via the GUI of the presence of John Doe in the area.

At this point, user equipment 124 may then directly contact user equipment 128, by any known P2P communication method, non-limiting examples of which include Wi-Fi and Bluetooth.

Returning to FIG. 6, method 600 then ends (S612).

Embodiments of present invention provide systems and methods for device discovery notification of only those individuals that are already connected via a social networking site. In general, embodiments of present invention provide users within a P2P network the ability to discover other devices in their vicinity, but under control of the network operator (wireless service provider). Further, in embodiments of the present invention, the application server controls which devices are allowed to be discovered based on the user of the device.

In various embodiments, users have the option of determining their discovery preferences. For example, a user may decide that he prefers his privacy and does not want others to be able to discover him, and thus he may communicate to the application server that he does not want to be discoverable. In another example, a user may prefer not to discover others, and thus may communicate to the application server that he does not want to be notified of any other users in the area. In addition, any combination of the above preferences is also possible, depending on the preferences of the user. Preferences could be changed at any time by notifying the application server of the user's preferences.

The foregoing description of various embodiments have been presented for purposes of illustration and description. It is not intended to be exhaustive or to limit the invention to the precise forms disclosed, and many modifications and variations are possible in light of the above teaching.

What is claimed as new and desired to be protected by Letters Patent of the United States is:

1. A user equipment comprising:
a transmitting portion operable to transmit registration data to an application server and to transmit an authorization to the application server to access user data at a second server, the user data including a plurality of user names;
a receiving portion operable to receive, from the application server, a plurality of received user-IDs based on the user data, each of the plurality of user-IDs corresponding to one of the plurality of user names, respectively, and operable to receive, from a transmitting user equipment, a device-discovery request including a transmitting user-ID;
a determining portion operable to determine whether the transmitting user-ID corresponds to one of the plurality of received user-IDs; and
an indicating portion operable to provide a presence indication for the transmitting user equipment when the transmitting user-ID corresponds to one of the plurality of received user-IDs and to provide no presence indication for the transmitting user equipment when the transmitting user-ID does not correspond to one of the plurality of received user-IDs.

2. The user equipment of claim 1, wherein the plurality of received user-IDs comprises a list of user-IDs.

3. The user equipment of claim 1, wherein said transmitting portion is further operable to communicate with the transmitting user equipment when the transmitting user-ID corresponds to one of the plurality of received user-IDs.

4. The user equipment of claim 3, further comprising an override portion operable to prevent said transmitting portion from communicating with the transmitting user equipment when the transmitting user-ID corresponds to one of the plurality of received user-IDs.

5. The user equipment of claim 1,
wherein said transmitting portion is operable to transmit the authorization to the application server to access the user data at the second server, such that the user data includes additional user names in addition to the plurality of user names, and
wherein said receiving portion is further operable to receive, from the application server, the plurality of received user-IDs based on the user data, such that each of the plurality of user-IDs only corresponds to one of the plurality of user names, respectively, and not to the additional user names.

6. The user equipment of claim 1, wherein said receiving portion operable to receive, from the transmitting user equipment, the device-discovery request as a peer-to-peer probe request.

7. A method comprising:
transmitting, via a transmitting portion, registration data to an application server;
transmitting, via the transmitting portion, an authorization to the application server to access user data at a second server, the user data including a plurality of user names;
receiving, via a receiving portion and from the application server, a plurality of received user-IDs based on the user data, each of the plurality of received user-IDs corresponding to one of the plurality of user names, respectively;
receiving, via the receiving portion, a device-discovery request from a transmitting user equipment, the device-discovery request including a transmitting user-ID;
determining, via a determining portion, whether the transmitting user-ID corresponds to one of the plurality of received user-IDs;
providing, via an indicating portion, a presence indication for the transmitting user equipment when the transmitting user-ID corresponds to one of the plurality of received user-IDs, and
providing, via the indicating portion, no presence indication for the transmitting user equipment when the transmitting user-ID does not correspond to one of the plurality of received user-IDs.

8. The method of claim 7, wherein the plurality of received user-IDs comprises a list of user-IDs.

9. The method of claim 7, further comprising transmitting, via the transmitting portion, a communication to the transmitting user equipment when the transmitting user-ID corresponds to one of the plurality of received user-IDs.

10. The method of claim 9, further comprising preventing, via an override portion, the transmitting portion from transmitting the communication to the transmitting user equipment when the transmitting user-ID corresponds to one of the plurality of received user-IDs.

11. The method of claim 7,
wherein said transmitting, via the transmitting portion, an authorization to the application server to access user data at a second server, the user data including a plurality of user names comprises transmitting the authorization to the application server to access the user data at the second server, such that the user data includes additional user names in addition to the plurality of user names, and
wherein said receiving, via a receiving portion and from the application server, a plurality of received user-IDs based on the user data, each of the plurality of received user-IDs corresponding to one of the plurality of user names, respectively, comprises receiving the plurality of received user-IDs based on the user data, such that each of the plurality of user-IDs only corresponds to one of the plurality of user names, respectively, and not to the additional user names.

12. The method of claim 7, wherein said receiving, via the receiving portion, a device-discovery request from a transmitting user equipment, the device-discovery request including a transmitting user-ID comprises receiving the device-discovery request as a peer-to-peer probe request.

13. A computer-readable media having computer-readable instructions stored thereon, the computer-readable instructions being capable of being read by a computer, the computer-readable instructions being capable of instructing the computer to perform the method comprising:
transmitting, via a transmitting portion, registration data to an application server;
transmitting, via the transmitting portion, an authorization to the application server to access user data at a second server, the user data including a plurality of user names;
receiving, via a receiving portion and from the application server, a plurality of received user-IDs based on the user data, each of the plurality of received user-IDs corresponding to one of the plurality of user names, respectively;
receiving, via the receiving portion, a device-discovery request from a transmitting user equipment, the device-discovery request including a transmitting user-ID;
determining, via a determining portion, whether the transmitting user-ID corresponds to one of the plurality of received user-IDs;
providing, via an indicating portion, a presence indication for the transmitting user equipment when the transmitting user-ID corresponds to one of the plurality of received user-IDs, and
providing, via the indicating portion, no presence indication for the transmitting user equipment when the transmitting user-ID does not correspond to one of the plurality of received user-IDs.

14. The computer-readable media of claim 13, the computer-readable instructions being capable of instructing the computer to perform the method wherein the plurality of received user-IDs comprises a list of user-IDs.

15. The computer-readable media of claim 13, the computer-readable instructions being capable of instructing the computer to perform the method further comprising transmitting, via the transmitting portion, a communication to the transmitting user equipment when the transmitting user-ID corresponds to one of the plurality of received user-IDs.

16. The computer-readable media of claim 13, the computer-readable instructions being capable of instructing the computer to perform the method further comprising preventing, via an override portion, the transmitting portion from transmitting the communication to the transmitting user equipment when the transmitting user-ID corresponds to one of the plurality of received user-IDs.

17. The computer-readable media of claim 13,
the computer-readable instructions being capable of instructing the computer to perform the method wherein said transmitting, via the transmitting portion, an authorization to the application server to access user data at a second server, the user data including a plurality of user names comprises transmitting the authorization to the application server to access the user data at the second server, such that the user data includes additional user names in addition to the plurality of user names, and
the computer-readable instructions being capable of instructing the computer to perform the method wherein said receiving, via a receiving portion and from the application server, a plurality of received user-IDs based on the user data, each of the plurality of received user-IDs corresponding to one of the plurality of user names, respectively, comprises receiving the plurality of received user-IDs based on the user data, such that each of the plurality of user-IDs only corresponds to one of the plurality of user names, respectively, and not to the additional user names.

18. The computer-readable media of claim 13, the computer-readable instructions being capable of instructing the computer to perform the method wherein said receiving, via the receiving portion, a device-discovery request from a transmitting user equipment, the device-discovery request including a transmitting user-ID comprises receiving the device-discovery request as a peer-to-peer probe request.
